(19) United States
(12) Patent Application Publication
(10) Pub. No.: US 2014/0131187 A1
(43) Pub. Date: May 15, 2014

(54) Heat-Spot Distant Type Push Switch Structure

(71) Applicant: SOLTEAM ELECTRONICS CO., LTD., Taoyuan (TW)

(72) Inventors: Ying-Sung Ho, Taoyuan (TW); Chen-Hong Huang, Taoyuan (TW); Chang-Nan Chen, Taoyuan (TW); Cheng-Wei Lu, Taoyuan (TW); Chao-Yi Lee, Taoyuan (TW); Tao-Lung Hsueh, Taoyuan (TW)

(73) Assignee: SOLTEAM ELECTRONICS CO., LTD., Taoyuan (TW)

(21) Appl. No.: 13/674,012

(22) Filed: Nov. 10, 2012

(51) Int. Cl. H01H 3/32

(52) U.S. Cl. CPC H01H 3/32
USPC 200/520

(57) ABSTRACT

Heat-spot distant type push switch structure comprises: a supporting terminal, a compression spring, a switching spring, an electrical terminal, and a sliding lever assembly. Compression spring, switching spring and the switching member of the sliding lever assembly are stacked for connection and facilitate the occupied space of the heat-spot distant type push switch structure capable of being reduced; moreover, the supporting terminal, the compression spring, the switching spring, the electrical terminal, and the sliding lever assembly are designed to particular structures for forming a specific distant between the switching member and the touch point of two contact points of the heat-spot distant type push switch structure, such that the switching member is away from the heat-spot produced by the two contact points; therefore the switching member can still not be fused after the heat-spot distant type push switch structure is long-term used.

### BACKGROUND OF THE INVENTION

1. Field of the Invention

The present invention relates to a switch structure applied in push switches, and more particularly to a heat-spot distant type push switch structure.

2. Description of the Prior Art

“Switch” is a necessary mechanism for electrical equipments and electronic products, such as refrigerators, TVs, extension cords, computers, and video game consoles, all the aforesaid equipments and devices need the switch for turning on/off the power thereof. Push switch is the most conventional used switch.

Please refer to FIG. 1 and FIG. 2, there are shown a stereo and a side cross-sectional views of a conventional push switch. As shown in FIG. 1 and FIG. 2, the conventional push switch 1′ mainly includes: a housing 11′, a push switching member 12′, a first terminal 13′, a second terminal 14′, and a switching spring 15′, wherein the push switching member 12′, the first terminal 13′, the second terminal 14′, and the switching spring 15′ are disposed in the housing 11′, and the first terminal 13′ and the second terminal 14′ extend out of the housing 11′; besides, the end of the second terminals 14′ staying in the housing 11′ has a contact point 141′. As shown in FIGs., the push switching member 12′ includes a press portion 121′ and a swing portion 122′, wherein the swing portion 122′ has a propping stick 123′ for the switching spring 15′ disposed in the inside thereof, and the propping stick 123′ includes a spring 1231′. Moreover, the switching spring 15′ is connected to the first terminal 13 and has a contact point 151′ for contacting with the contact point 141′ of the second terminal 14′.

Please refer to FIG. 3A and FIG. 3B, which illustrate schematic motion diagrams of the conventional push switch. As shown in FIG. 3A, when the press portion 121′ of the push switching member 12′ is pressed for making the swing portion 122′ swing toward right side, the propping stick 123′ would bearing one end of the switching spring 15′, and then the end of the switching spring 15′ having the contact point 151′ would tilt up; meanwhile, the tilt-up contact point 151′ of the switching spring 15′ cannot contact with the contact point 141′ of the second terminal 14′, such that the first terminal 13′ cannot conduct to the second terminal 14′ via the switching spring 15′. On the contrary, as shown in FIG. 3B, when the press portion 121′ of the push switching member 12′ is pressed for making the swing portion 122′ swing toward left side, the propping stick 123′ would bearing the other end of the switching spring 15′, and then the end of the switching spring 15′ having the contact point 151′ would tilt down; meanwhile, the tilt-down contact point 151′ of the switching spring 15′ would contact with the contact point 141′ of the second terminal 14′, such that the first terminal 13′ conducts to the second terminal 14′ through the switching spring 15′.

In the conventional push switch 1′, the propping stick 123′ and the spring 1231′ is used for increasing the switch rating; in addition, the propping stick 123′ is made of metal for avoiding from being melted. However, even if the use of the propping stick 123′ and the spring 1231′ make the conventional push switch 1′ has a higher switching rating, the structure of the propping stick 123′ and the spring 1231′ bring shortcomings and drawbacks for the conventional push switch 1′ as follows:

(1) As shown in FIG. 3B, when the push switching member 12′ is pressed for making the first terminal 13′ conduct to the second terminal 14′ via the switching spring 15′, the propping stick 123′ closes to the touch point of the first terminal 13′ and the second terminal 14′; So that, the metal-made propping stick 123′ may be fused and melted after the conventional push switch 1′ is long-term used. (Because large current would pass through the touch point of the first terminal 13′ and the second terminal 14′ when the push switch 1′ is switched on, this touch point is also called “heat-spot”.)
(2) Although the metal-made propping stick 123′ make the push switch 1′ has a higher switching rating, the metal-made propping stick 123′ causes increment of the manufacturing cost for the push switch 1′.
(3) Inheriting to above point 2, moreover, the housing 11′ of the push switch 1′ is designed to include large interior space for accommodating the swing portion 122′ of the push switching member 12′, the propping stick 123′, the spring 1231′, and the switching spring 15′, and that causes the entire volume of the push switch 1′ cannot to be effectively shrunk.
(4) Inheriting to above point 3, furthermore, what is important is that, although the propping stick 123′ and spring 1231′ can enhance the contact force of the switching spring 15′ and the second terminal 14′, the enhanced contact force causes the push switching member 12′ be pressed and switched hard.

Actually, besides the above-mentioned three drawbacks, the push switch 1′ further includes a shortcoming, that is the push switch 1′ cannot be switched quickly. So that, for the conventional push switch 1′ has many shortcomings and drawbacks, the push switch 1′ can merely applied in household appliances and some electronic devices but in powered hand tools. Accordingly, the switch manufacturers propose a microactive switch. Please refer to FIG. 4. which illustrates a stereo view of a microactive switch, moreover, in FIG. 5, it shows the stereo view of a switch mechanism assembly of the microactive switch. The microactive switch 1″ shown in FIG. 4 is a switch device capable of being applied in the powered hand tools, and this microactive switch 1″ includes a switch mechanism assembly 11″.

The switch mechanism assembly 11″ consists of a first terminal 111″, a second terminal 112″, a third terminal 113″, a first spring 114″, a second spring 115″, a sliding lever 116″, and a return spring 117″, wherein the second terminal 112″ has a first contact point 1121″ and the third terminal 113″ has a second contact point 1131″. The first spring 114″ and the second spring 115″ are disposed on the first terminal 111″ and include a third contact point 1141″ and a fourth contact point 1151″, respectively. The third contact point 1141″ and the fourth contact point 1151″ are opposite to the first contact point 1121″ and the second contact point 1131″. Besides, the sliding lever 116″ includes an extension bar 1161″ and a sliding block 1162″, wherein the extension bar 1161″ is provided with the return spring 117″ and the sliding block 1162″ has two protrusion portions 1163″ on the bottom thereof (one protrusion portion 1163″ is shielded by the sliding block 1162″.)

Continuously, please refer to FIG. 6, there is shown the motion diagram of the switch mechanism assembly. As shown in FIG. 4 and FIG. 6, when the press member 12″ of the switch mechanism assembly 11″ is pressed for making the sliding lever 116″ move toward the inside of the microactive switch 1″, one protrusion portion 1163″ of the sliding lever 116″ would propping against the first spring 114″ and make the end of the first spring 114″ having the third contact point 1141″ tilt down; meanwhile, the tilt-down third contact point 1141″ would touch with the first contact point 1121″ of the second terminal 112″, such that the first terminal 111″ conduct to the second terminal 112″ via the first spring 114″. Furthermore, when the press member 12″ continuously is pressed for making the sliding lever 116″ constantly move toward the inside of the microactive switch 1″, the sliding lever 116″ would make the end of the second spring 115″ having the fourth contact point 1151″ tilt down; meanwhile, the tilt-down fourth contact point 1151″ would touch with the second contact point 1131″ of the third terminal 113″, such that the first terminal 111″ conduct to the third terminal 113″ through the second spring 115″.

By above descriptions, it is able to know that the switch of the switch mechanism assembly 11′ is carried out by way of moving the sliding lever 116″ to change the arm force directions of the first spring 114″ and the second spring 115″. So that, the mainly advantages of the switch mechanism assembly 11′ are small occupied space and able to be quickly switch. However, even if this switch mechanism assembly 11′ solves the drawbacks of the conventional push switch 1′, the switch mechanism assembly 11′ still includes the shortcomings and drawbacks as follows:

(A) As shown in FIG. 6, the switch mechanism assembly 11′ mainly utilizes the protrusion portions 1163″ of the sliding lever 116″ to prop against the first spring 114″ for keeping the contact of the third contact point 1141″ and the first contact point 1121″, therefore, when the protrusion portions 1163″ of the sliding lever 116″ are slowly away from the first spring 114″, the third contact point 1141″ and the first contact point 1121″ cannot be kept in touch steadily. For above reasons, it needs to keep the force on the press member 12″ for making the protrusion portions 1163″ constantly prop against the first spring 114″, so as to facilitate the third contact point 1141″ and the first contact point 1121″ able to be kept in touch steadily.
(B) For the switch mechanism assembly 11′, the first spring 114″ and the second spring 115″ may lose their springiness gradually after the switch mechanism assembly 11′ is long-term used; therefore, it needs to increase the force on the press member 12″ for facilitating the third contact point 1141″ and the first contact point 1121″ able to be kept in touch steadily. Besides, when the microactive switch 1″ is operated on rapid switching, the first spring 114″ and the second spring 115″ of the switch mechanism assembly 11″ may be influenced by high temperature, and that causes the switching rating of microactive switch 1″ be not high.

Thus, in view of the conventional push switch and the microactive switch still have shortcomings and drawbacks, the inventor of the present application has made great efforts to make inventive research thereon and eventually provided a heat-spot distant type push switch structure.

### SUMMARY OF THE INVENTION

The first objective of the present invention is to provide a heat-spot distant type push switch structure, in which a compression spring, a switching spring and a switching member are stacked for connection, and such stacked connection of the compression spring, the switching spring and the switching member facilitates the occupied space of the heat-spot distant type push switch structure capable of being reduced; moreover, by such mechanical structure design, the switching member would initially withstand the switching spring for opening two contacts points, without applying any other forces to the push switch; this mechanical structure design can enhance the durability of the push switch.

The second objective of the present invention is to provide a heat-spot distant type push switch structure, in which the supporting terminal, the compression spring, the switching spring, the electrical terminal, and the sliding lever assembly are designed to particular structures for forming a specific distant between the switching member and the touch point of two contact points, such that the switching member is away from the heat-spot produced by the two contact points; therefore the switching member can still not be fused after the heat-spot distant type push switch structure is long-term used.

The third objective of the present invention is to provide a heat-spot distant type push switch structure, in which the compression spring, the switching spring and the switching member are stacked for connection, therefore when two contact points contact to each other tightly, the driving force released by the compression spring produces a horizontal component force and a vertical component force, wherein the horizontal component force maintains the contact of the two contact points, and the vertical component force makes upper contact point down and press the lower contact point, so as to avoid the upper contact point from ricocheting off the lower contact point when the upper contact point is impacted by an external force.

Accordingly, to achieve the objectives of the present invention, the inventor of the present invention provides a heat-spot distant type push switch structure, comprising:

a supporting terminal;

a compression spring, connected to the supporting terminal by one end thereof;

a switching spring, having a first contact end, a switching member contacting end and a supporting terminal connecting end, wherein the first contact end has a spring connecting portion connected with the other end of the compression spring, and the supporting terminal connecting end being connected to the supporting terminal for facilitating the switching spring able to pivotally move up/down by using the supporting terminal as axes;

an electrical terminal, having a welding end, an extension section and a second contact end, wherein the extension section is connected with the welding end and the second contact end, and the second contact end being opposite to the supporting terminal in a free space, therefore the first contact end is able to touch the second contact end of the electrical terminal when the switching spring pivotally moves down; and

a sliding lever assembly, having a sliding bar, a sliding block and a switching member, wherein the sliding bar is disposed on the front end of the sliding block, and the switching member being disposed on the side end of the sliding block for initially withstanding the switching member contacting end of the switching spring, so as to make the first contact end of the switching spring away from the second contact end of the electrical terminal, and making the compression spring stay in a compressive state; moreover, the sliding lever assembly is adjacent to the electrical terminal in the free space, and the switching member is located over the extension section of the electrical terminal and below the supporting terminal;

wherein when pressing the sliding lever assembly for making the sliding bar and the sliding block move toward negative X-axis in the free space, the switching member being away from the switching member contacting end of the switching spring, meanwhile the compression spring staying in a releasing state and releasing a driving force by a specific angle in the free space;

wherein the driving force makes the switching spring pivotally move down by using the supporting terminal as axes, and then the first contact end of the switching spring tightly contacts with second contact end of the electrical terminal; therefore the supporting terminal conducts to the electrical terminal via the switching spring, and a specific distance is formed between the switching member and the contact point of the first contact end and the second contact end.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a stereo view of a conventional push switch;

FIG. 2 is a side cross-sectional view of the conventional push switch;

FIG. 3A and FIG. 3B are schematic motion diagrams of the conventional push switch;

FIG. 4 is a stereo view of a microactive switch;

FIG. 5 is A stereo view of a switch mechanism assembly of the microactive switch;

FIG. 6 is a schematic motion diagram of the switch mechanism assembly;

FIG. 7 is a stereo view of a heat-spot distant type push switch structure according to the present invention;

FIG. 8 is an exploded view of the heat-spot distant type push switch structure;

FIG. 9A and FIG. 9B are schematic motion diagrams of the heat-spot distant type push switch structure; and

FIG. 10 is a stereo view of a housing for accommodating the heat-spot distant type push switch structure.

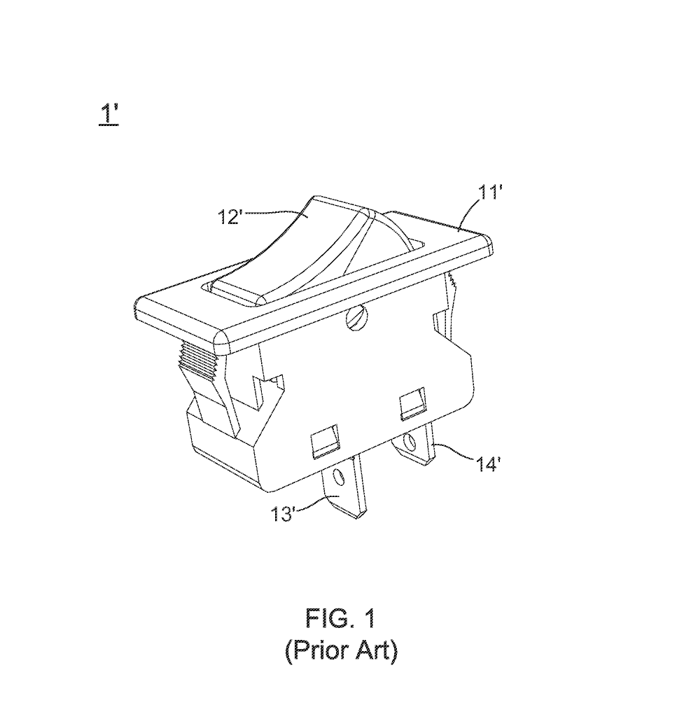

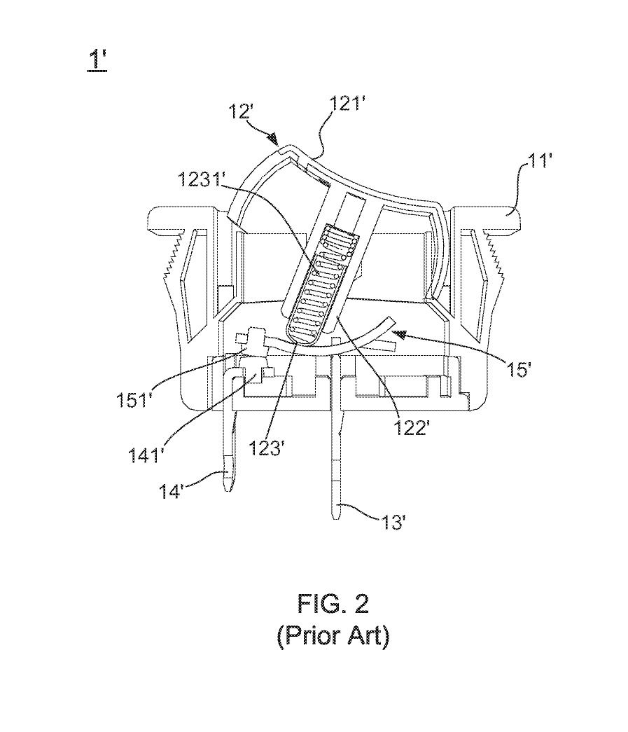

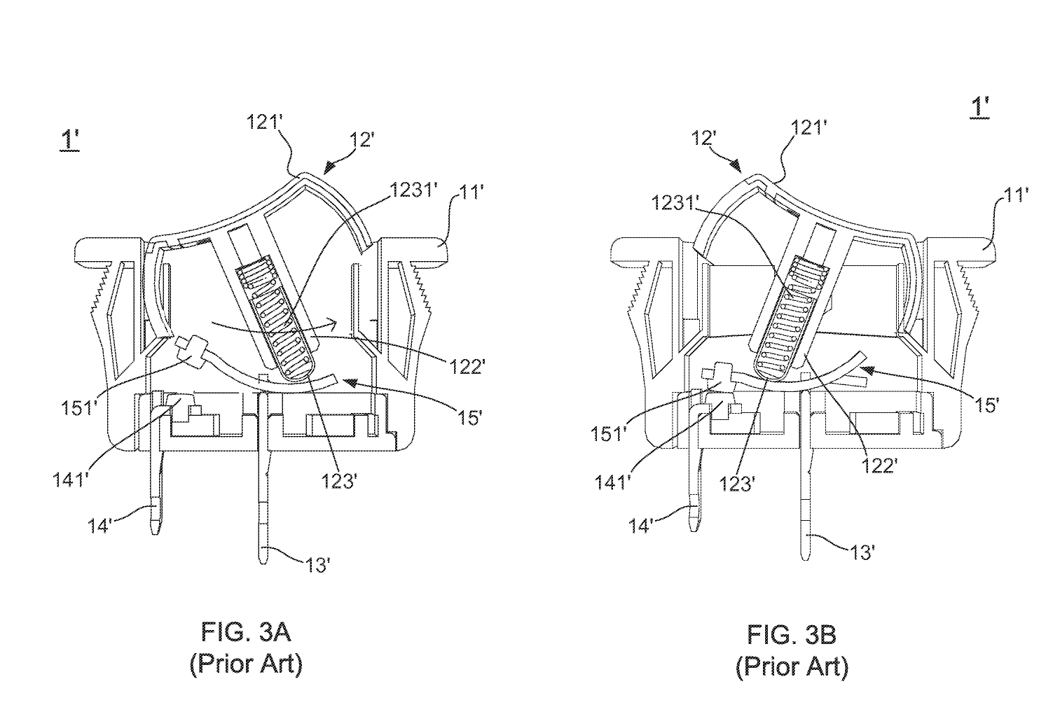

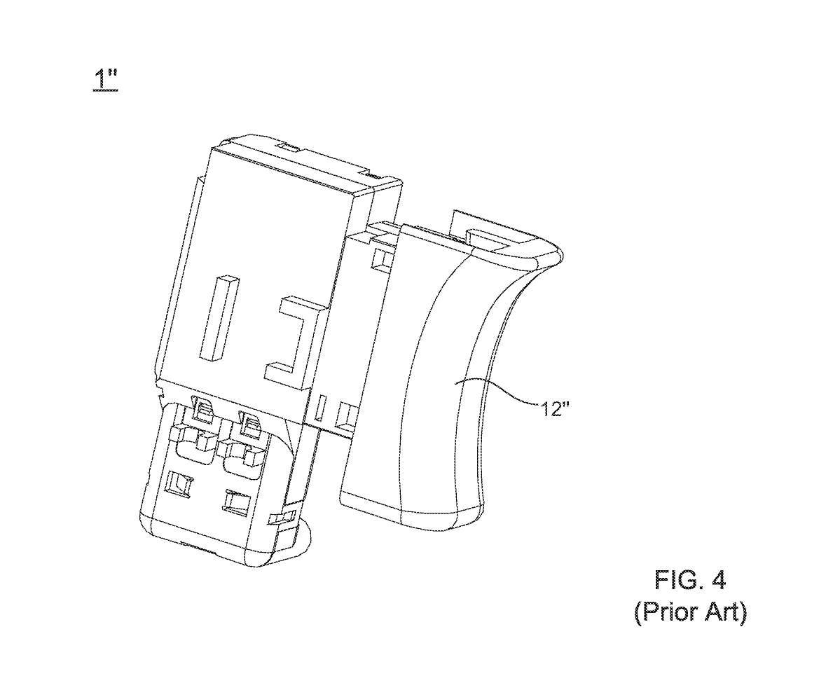

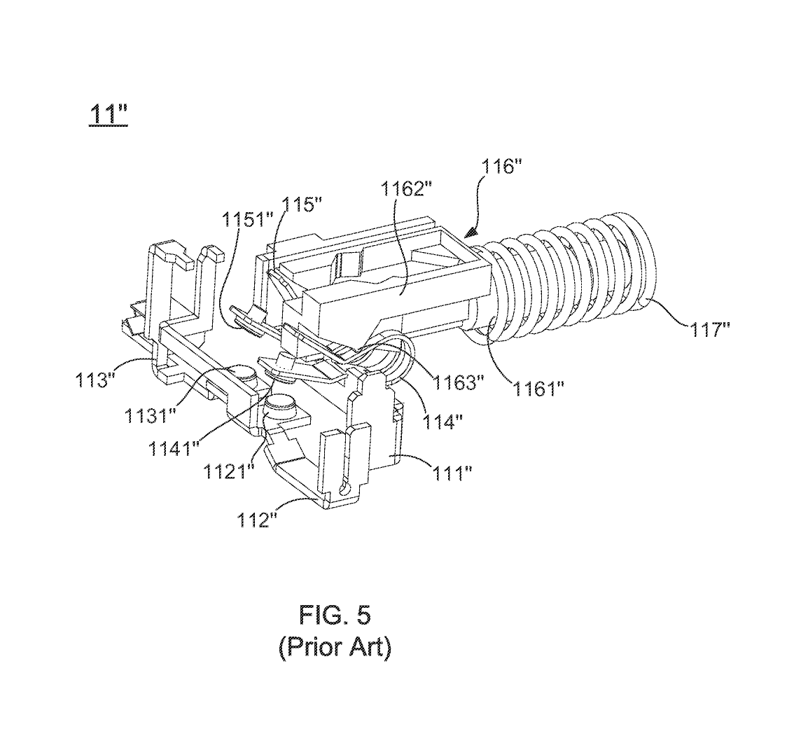

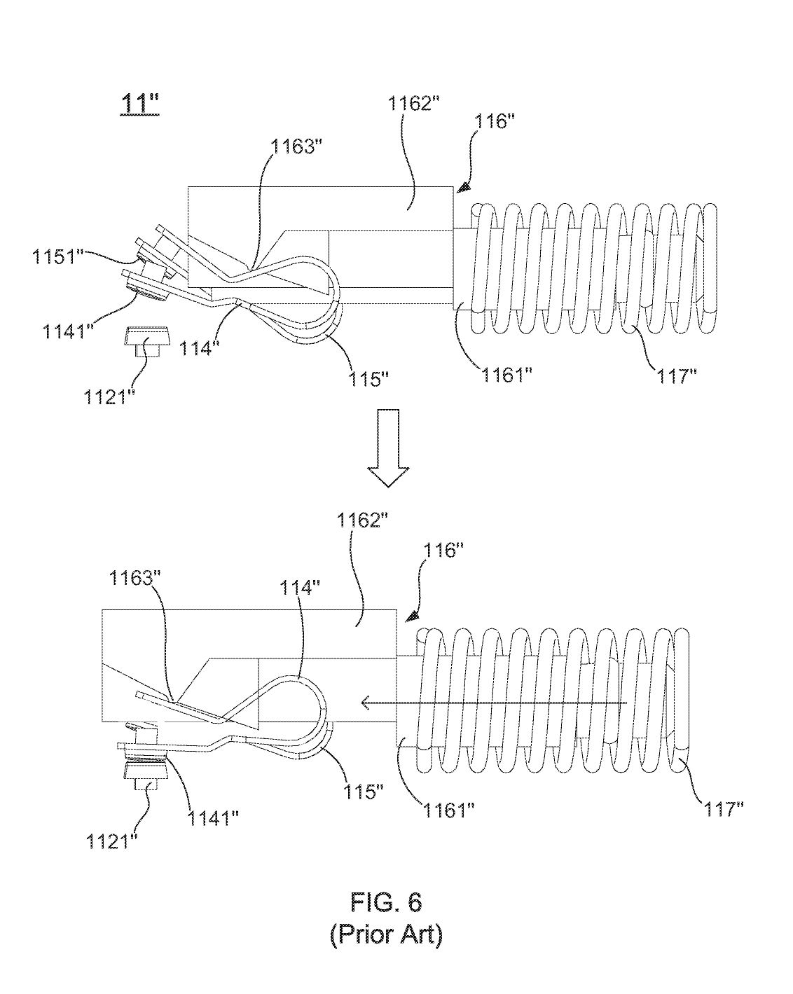

### DETAILED DESCRIPTION OF THE PREFERRED EMBODIMENTS

To more clearly describe a heat-spot distant type push switch structure according to the present invention, embodiments of the present invention will be described in detail with reference to the attached drawings hereinafter.

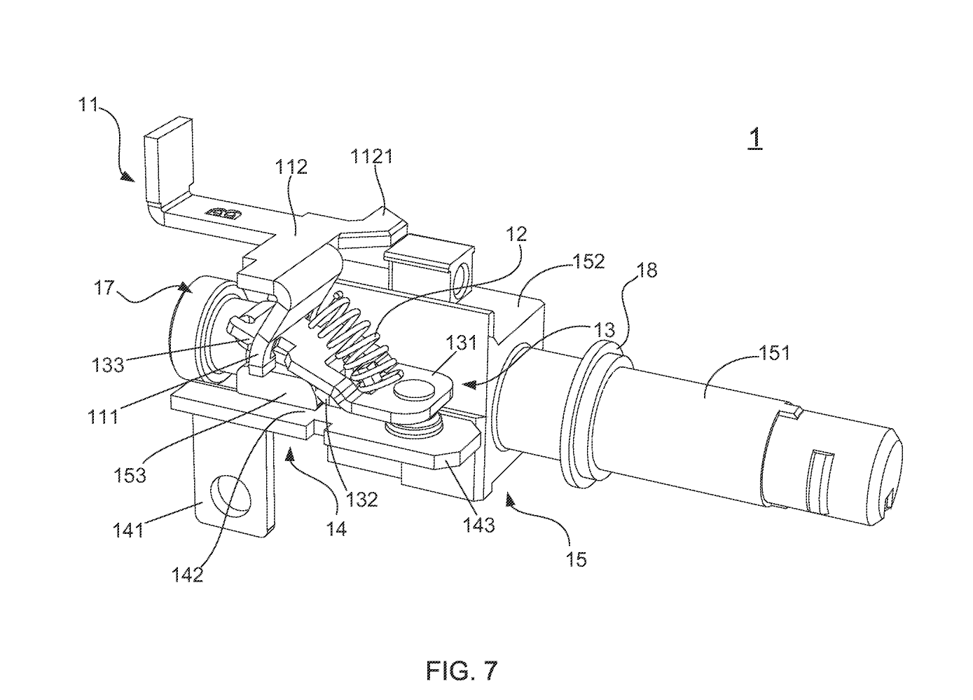

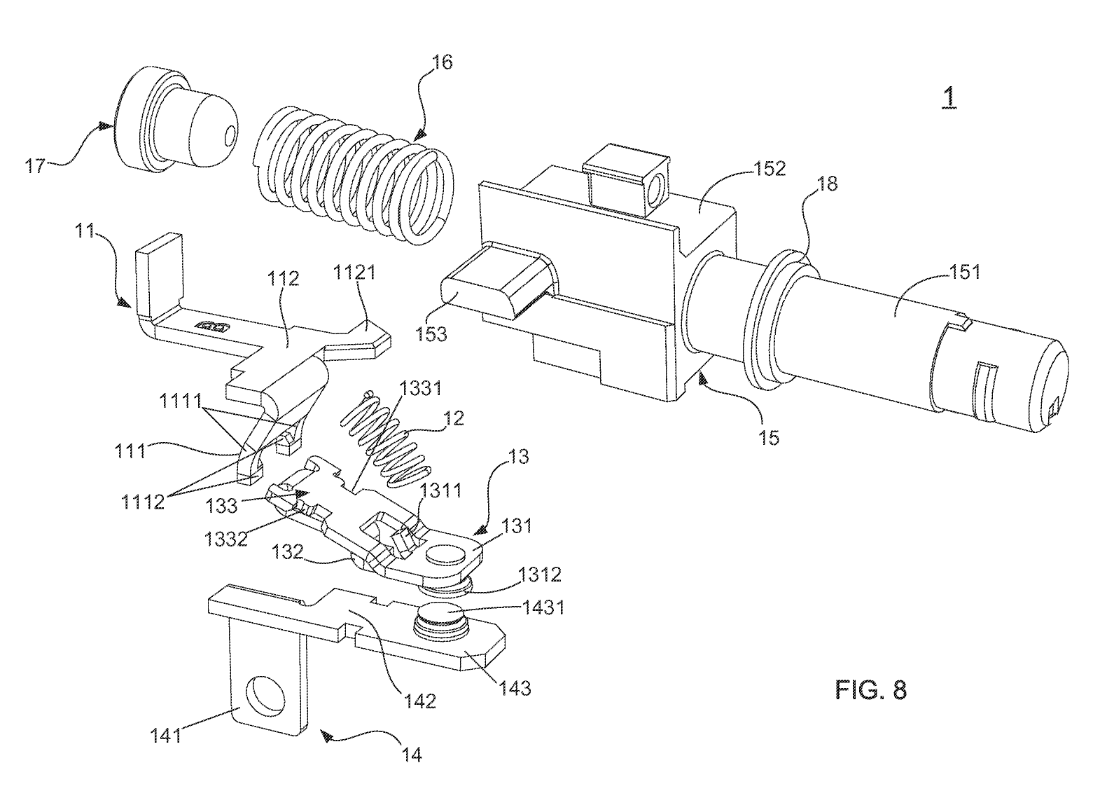

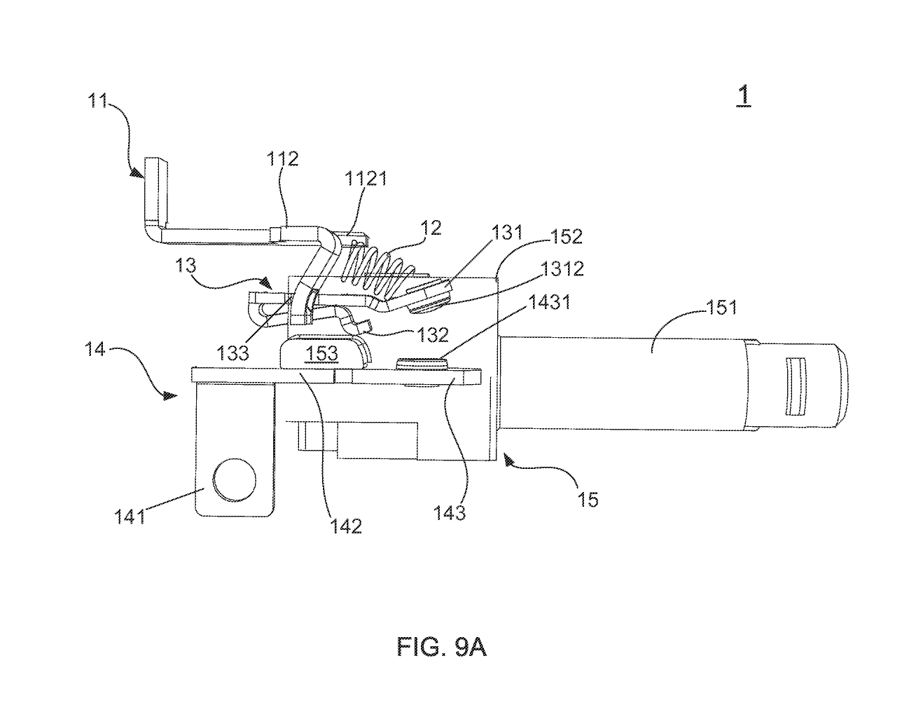

Please refer to FIG. 7 and FIG. 8, there are shown a stereo view and an exploded view of a heat-spot distant type push switch structure according to the present invention. As shown in FIG. 7 and FIG. 8, the heat-spot distant type push switch structure 1 includes: a supporting terminal 11, a compression spring 12, a switching spring 13, an electrical terminal 14, a sliding lever assembly 15, a return spring 16, and a return spring fixing base 17, wherein the compression spring 12 is connected to the supporting terminal 11 by one end thereof. The supporting terminal 11 includes a switching spring connecting end 111 and an exposing end 112, and the switching spring connecting end 111 has two supporting portions 1111 and two clasping portions 1112.

As shown in FIGs., the switching spring 13 includes a first contact end 131, a switching member contacting end 132 and a supporting terminal connecting end 133, wherein the first contact end 131 has a spring connecting portion connected with the other end of the compression spring 12, and the first contact end 131 is provided with a first contact silver point 1312. The supporting terminal connecting end 133 has two recess portions 1331 and two protrusion portions 1332, which used for cooperating with the two supporting portions 1111 and the two clasping portions 1112, so as to make the supporting terminal connecting end 133 of the switching spring 13 connect with the switching spring connecting end 111 of the supporting terminal 11, and facilitate the switching spring 13 able to pivotally move up/down by using the supporting terminal 11 as axes.

The electrical terminal 14 includes a welding end 141, an extension section 142 and a second contact end 143, wherein the extension section 142 is connected with the welding end 141 and the second contact end 143, and the second contact end 143 is provided with a second contact silver point 1431. In the heat-spot distant type push switch structure 1, the electrical terminal 14 is opposite to the supporting terminal 11 in a free space, therefore the first contact silver point 1312 of the first contact end 131 is able to touch the second contact silver point 1431 of the second contact end 143 when the switching spring 13 pivotally moves down.

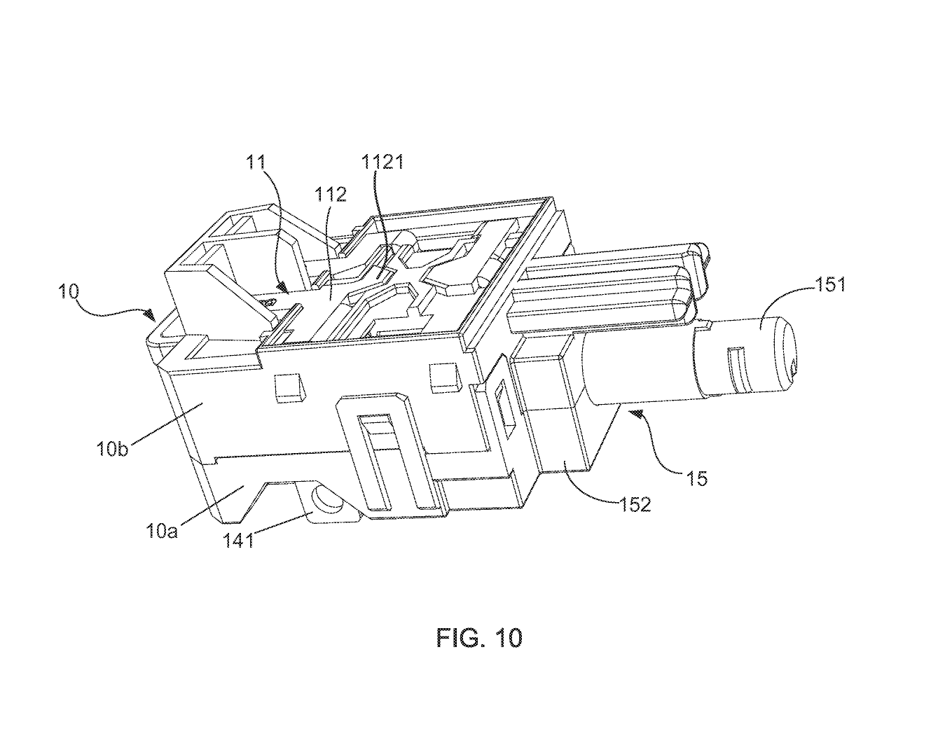

Continuously referring to FIG. 7 and FIG. 8, the sliding lever assembly 15 includes a sliding bar 151, a sliding block 152 and a switching member 153, wherein the sliding bar 151 is disposed on the front end of the sliding block 152, and the switching member 153 is disposed on the side end of the sliding block 152 for initially withstanding the switching member contacting end 132 of the switching spring 13, so as to make the first contact end 131 of the switching spring 13 away from the second contact end 143 of the electrical terminal 14, and make the compression spring 12 stay in a compressive state. Moreover, the sliding lever assembly 15 is adjacent to the electrical terminal 14 in the free space, and the switching member 153 is located over the extension section 14 of the electrical terminal 14 and below the supporting terminal 11. Besides, the return spring 16 is connected to the sliding block 152 of the sliding lever assembly 15 by one end thereof, and the return spring fixing base 17 is connected to the other end of the return spring 16 for fixing the return spring 16. In addition, a dust wiper 18 is disposed on the sliding bar 151 of the sliding lever assembly 15 and accommodated by a housing constituted by a base 10a and a cover 10b (the base 10a and the cover 10b are illustrated in following FIG. 10.).

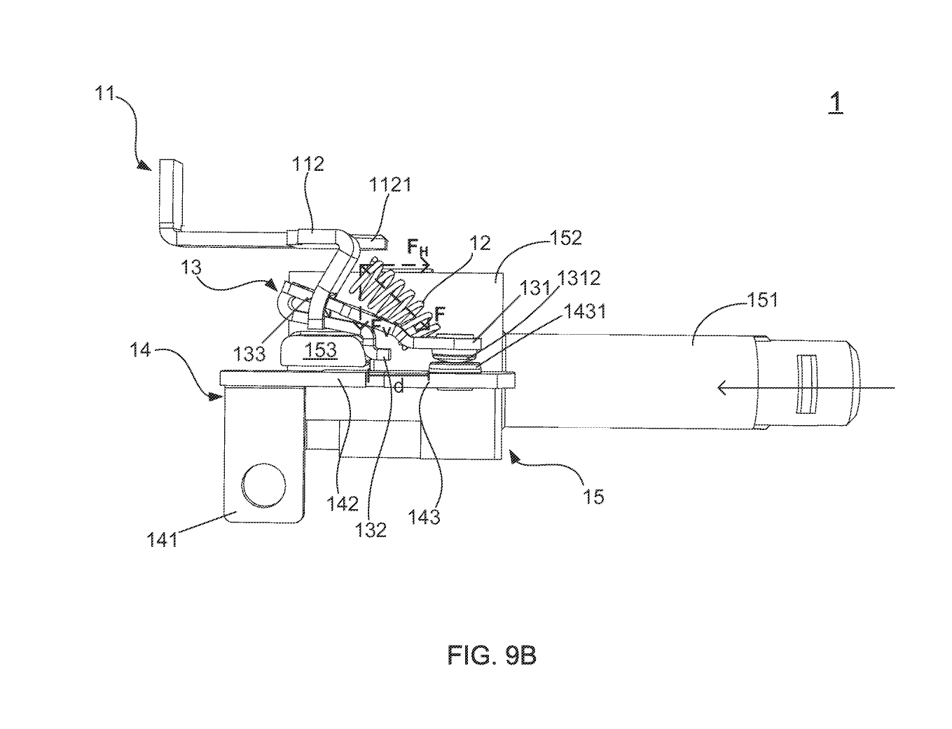

Thus, by above descriptions, the framework and the constituting elements of the heat-spot distant type push switch structure 1 of the present invention has been completely introduced. Next, the schematic motion diagrams will be shown and used for more clearly describing the function and technology feature of the heat-spot distant type push switch structure 1. Please refer to FIG. 9A and FIG. 9B, there are shown schematic motion diagrams of the heat-spot distant type push switch structure. As shown in FIG. 9A, the sliding block 152 of the sliding lever assembly 15 is initially adjacent to the extension section 142 and the second contact end 143 of the electrical terminal 14 in the free space, and the switching member 153 of the sliding lever assembly 15 withstands the switching member contacting end 132 of the switching spring 13 for making the first contact end 131 of the switching spring 13 away from the second contact end of the electrical terminal 14, and making the compression spring 12 stay in the compressive state. Furthermore, as shown in FIG. 9B, when pressing the sliding lever assembly 15 for making the sliding bar 151 and the sliding block 152 move toward negative X-axis in the free space, the switching member 153 is away from the switching member contacting end 132 of the switching spring 13, meanwhile the compression spring 12 stays in a releasing state and releases a driving force F by a specific angle in the free space. The driving force F makes the switching spring 13 pivotally move down by using the supporting terminal 11 as axes, and then the first contact end 131 of the switching spring 13 tightly contacts with second contact end 143 of the electrical terminal 14; therefore the supporting terminal 11 conducts to the electrical terminal 14 via the switching spring 13.

Particularly, in the heat-spot distant type push switch structure of the present invention, when the first contact end 131 of the switching spring 13 tightly contacts with the second contact end 143 of the electrical terminal 14, there has a specific distance d formed between the switching member 153 and the contact point of the first contact end 131 and the second contact end 143, and the specific distance d make the switching member 153 away from the heat-spot formed by the contact point of the first contact end 131 and the second contact end 143. So that, the switching member 153 would not be fused or melted even if the push switch structure of the present invention has been long-term used.

Moreover, as shown in FIG. 9B, when the compression spring 12 stays in the releasing state, the driving force F is released by the specific angle ranged from 30-degree to 60-degree. The driving force F includes a horizontal component force F_{H} and a vertical component force F_{V}, in which the horizontal component force F_{H} maintains the contact of the first contact end 131 and the second contact end 143, and the vertical component force F_{V} makes the first contact end 131 down and press the second contact end 143, so as to avoid the first contact end 131 from ricocheting off the second contact end 143 when the first contact end 131 is impacted by an external force. The horizontal component force F_{H} and the vertical component force F_{V} are the technology feature of the heat-spot distant type push switch structure 1.

Please refer to FIG. 10, it shows a housing for accommodating the heat-spot distant type push switch structure. As shown in FIG. 10, a housing is necessary for accommodating the supporting terminal 11, the compression spring 12, the switching spring 13, the electrical terminal 14, the sliding lever assembly 15 when practically applying the heat-spot distant type push switch structure 1 of the present invention. The housing is constituted by a base 10a and a cover 10b, and the welding end 141 of the electrical terminal 14 and the sliding bar 151 of the sliding lever assembly 15 are extended out of the housing. Besides, the exposing end 112 of the supporting terminal 11 is exposed out of the cover 10b and having a terminal contacting end 1121. The terminal contacting end 1121 is used for cooperating with a polarity reversing terminal, so as to change the polarity of the supporting terminal 11 electrically connected with the electrical terminal 14.

Thus, through the descriptions, the heat-spot distant type push switch structure of the present invention has been completely introduced and disclosed; in summary, the present invention has the following advantages:

1. As shown in FIG. 7, by way of disposing the switching member 153 on the side end of the sliding block 152 of the sliding lever assembly 15, and accordingly disposing the switching spring 13 and the compression spring 12 on the supporting terminal 11, the compression spring 12, the switching spring 13 and the switching member 153 are stacked for connection, and such stacked connection of the compression spring 12, the switching spring 13 and the switching member 153 facilitates the occupied space of the heat-spot distant type push switch structure capable of being reduced.
2. Inheriting to above point 1, by such mechanical structure design, the switching member 153 would initially withstand the switching member contacting end 132 of the switching spring 13, and then the first contact end 131 of the switching spring 13 is made be away from the second contact end 143 of the electrical terminal 14; This mechanical structure design can easily keep the heat-spot distant type push switch structure 1 in OFF state, without applying any other forces to the push switch; so that this mechanical structure design can enhance the durability of the push switch.
3. In addition, what is important is that, in the heat-spot distant type push switch structure 1 shown in the FIG. 9B, when the first contact end 131 of the switching spring 13 tightly contacts with the second contact end 143 of the electrical terminal 14, there has a specific distance d formed between the switching member 153 and the contact point of the first contact end 131 and the second contact end 143, and the specific distance d make the switching member 153 away from the heat-spot formed by the contact point of the first contact end 131 and the second contact end 143. So that, the switching member 153 would not be fused or melted even if the push switch structure of the present invention has been long-term used.
4. Inheriting to above point 3, since the distance d makes the switching member 153 away from the heat-spot, the manufacturing material for the switching member 153 becomes selectivity and is not limited to metal.
5. Inheriting to above point 3, moreover, when the first contact end 131 of the switching spring 13 tightly contacts with the second contact end 143 of the electrical terminal 14, the driving force F released by the compression spring 12 produces a horizontal component force F_{H} and a vertical component force F_{V}, in which the horizontal component force F_{H} maintains the contact of the first contact end 131 and the second contact end 143, and the vertical component force F_{V} makes the first contact end 131 down and press the second contact end 143, so as to avoid the first contact end 131 from ricocheting off the second contact end 143 when the first contact end 131 is impacted by an external force. The horizontal component force F_{H} and the vertical component force F_{V} are the technology feature of the heat-spot distant type push switch structure 1.
6. Inheriting to above point 2, the heat-spot distant type push switch structure 1 of the present invention allows users to easily switch on/off by slightly pressing the sliding lever assembly 15 for controlling the motion of the sliding block 152 and the switching member 153.

The above description is made on embodiments of the present invention. However, the embodiments are not intended to limit scope of the present invention, and all equivalent implementations or alterations within the spirit of the present invention still fall within the scope of the present invention.

What is claimed is:

1. A heat-spot distant type push switch structure, comprising:
a supporting terminal;
a compression spring, being connected to the supporting terminal by one end thereof;
a switching spring, having a first contact end, a switching member contacting end and a supporting terminal connecting end, wherein the first contact end has a spring connecting portion connected with the other end of the compression spring, and the supporting terminal connecting end being connected to the supporting terminal for facilitating the switching spring able to pivotally move up/down by using the supporting terminal as axes;
an electrical terminal, having a welding end, an extension section and a second contact end, wherein the extension section is connected with the welding end and the second contact end, and the second contact end being opposite to the supporting terminal in a free space, therefore the first contact end is able to touch the second contact end of the electrical terminal when the switching spring pivotally moves down; and
a sliding lever assembly, having a sliding bar, a sliding block and a switching member, wherein the sliding bar is disposed on the front end of the sliding block, and the switching member being disposed on the side end of the sliding block for initially withstanding the switching member contacting end of the switching spring, so as to make the first contact end of the switching spring away from the second contact end of the electrical terminal, and making the compression spring stay in a compressive state; moreover, the sliding lever assembly is adjacent to the electrical terminal in the free space, and the switching member is located over the extension section of the electrical terminal and below the supporting terminal;
wherein when pressing the sliding lever assembly for making the sliding bar and the sliding block move toward negative X-axis in the free space, the switching member being away from the switching member contacting end of the switching spring, meanwhile the compression spring staying in a releasing state and releasing a driving force by a specific angle in the free space;
wherein the driving force makes the switching spring pivotally move down by using the supporting terminal as axes, and then the first contact end of the switching spring tightly contacts with second contact end of the electrical terminal; therefore the supporting terminal conducts to the electrical terminal via the switching spring, and a specific distance is formed between the switching member and the contact point of the first contact end and the second contact end.

2. The heat-spot distant type push switch structure of claim 1, further comprising a base and a cover for constituting an housing for accommodating the supporting terminal, the compression spring, the switching spring, the electrical terminal, the sliding lever assembly, and the welding end of the electrical terminal and the sliding bar of the sliding lever assembly being extended out of the housing.

3. The heat-spot distant type push switch structure of claim 2, wherein the supporting terminal connecting end of the switching spring comprises two recess portions and two protrusion portions.

4. The heat-spot distant type push switch structure of claim 3, wherein the supporting terminal comprises:
a switching spring connecting end, having two supporting portions and two clasping portions, which used for cooperating with the two recess portions and the two protrusion portions, so as to make the supporting terminal connecting end of the switching spring connect with the switching spring connecting end of the supporting terminal; and
an exposing end, being exposed out of the cover and having a terminal contacting end.

5. The heat-spot distant type push switch structure of claim 2, further comprising:
a return spring, being connected to the sliding block of the sliding lever assembly by one end thereof;
a return spring fixing base, being connected to the other end of the return spring, so as to fix the return spring; and
a dust wiper, being disposed on the sliding bar of the sliding lever assembly and accommodated by the housing consisting of the base and the cover.

6. The heat-spot distant type push switch structure of claim 1, wherein the first contact end and the second contact end are provided with a first contact silver point and a second contact silver point, respectively.

7. The heat-spot distant type push switch structure of claim 1, wherein the specific angle is ranged from 30-degree to 60-degree.

8. The heat-spot distant type push switch structure of claim 7, wherein the driving force released by the compression spring includes a horizontal component force and a vertical component force; the horizontal component force maintaining the contact of the first contact end and the second contact end, and the vertical component force making the first contact end down and press the second contact end, so as to avoid the first contact end from ricocheting off the second contact end when the first contact end is impacted by an external force.
